(19) United States
(12) Patent Application Publication
(10) Pub. No.: US 2025/0136298 A1
(43) Pub. Date: May 1, 2025

(54) PROPULSION STAGE OF A LAUNCH VEHICLE, LAUNCH VEHICLE AND METHOD OF OPERATING A LAUNCH VEHICLE

(71) Applicant: Sascha Larch, Neusaess (DE)

(72) Inventor: Sascha Larch, Neusaess (DE)

(21) Appl. No.: 18/942,534

(22) Filed: Nov. 9, 2024

Related U.S. Application Data
(63) Continuation of application No. PCT/EP2023/062153, filed on May 8, 2023.

(30) Foreign Application Priority Data
May 9, 2022 (DE) 102022111499.6

(51) Int. Cl. B64G 1/00; B64G 1/40; B64G 1/42

(52) U.S. Cl. CPC B64G 1/008; B64G 1/401; B64G 1/425

(57) ABSTRACT

A propulsion stage for a launch rocket, the propulsion stage comprising: a rocket body having a longitudinal axis; at least one recoil propulsion unit acting substantially parallel to the longitudinal axis, wherein a liquid propellant is supplyable to the at least one recoil propulsion unit from at least one propellant tank through at least one fuel pump; and a plurality of rotor assemblies, each drivable by a rotor drive including at least one motor, wherein the at least one motor of at least one of the rotor drives is configured to selectively drive at least one of the rotor assemblies and/or the at least one fuel pump of the at least one recoil propulsion unit.

### RELATED APPLICATIONS

This application is a continuation of international patent application PCT/EP2023/062153 filed on May 8, 2023 claiming priority from German patent application DE 10 2022 111 499.6 filed on May 9, 2022, both of which are incorporated in their entirety by this reference.

### FIELD OF THE INVENTION

The present invention relates to a propulsion stage, in particular a reusable propulsion stage, of a launch rocket according to the pre-characterizing portion of the independent claim. It further relates to a launch rocket with at least one such propulsion stage and a method for operating such a launch rocket.

### BACKGROUND OF THE INVENTION

Launch rockets intended for flight into space usually have a multi-stage design, whereby a first propulsion stage equipped with recoil propulsion units propels the launch rocket into the upper regions of the troposphere up to the upper region of the stratosphere or even beyond, at an altitude of around 50 to 70 km, where a second propulsion stage is then ignited to transport the launch rocket into orbit or onto an interplanetary trajectory. The first propulsion stage falls back to earth after the engines have terminated burning and the second propulsion stage usually burns up on re-entry into the atmosphere.

For some years now, successful attempts have been made to land first stages equipped with recoil propulsion units in a controlled manner after firing so that they can be reused. Such reuse of rocket stages is desirable for economic reasons. The reusable rocket stages known to date land with the aid of controlled operation of their rocket motors and must be brought into a suitable position for a sufficient braking effect of these recoil propulsion units intended for the rocket launch when falling back to earth, which requires the provision of additional control nozzles. In addition, fuel reserves must still be available for the planned landing when falling back to earth (and possibly even when re-entering the earth's atmosphere).

WO 2020/094 640 A1 describes a two-stage launch rocket for space flight which, in addition to a recoil propulsion unit along the side of a cylindrical fuselage of the first stage, is equipped with electric duct blowers whose duct and rotation axis extends orthogonally to the longitudinal axis of the launch rocket. These blowers can act as generators when the stage falls back to earth and recharge the batteries for the blower motors. The blowers are used to ensure a controlled landing of the returned stage. The provision of electric blowers and the associated blower motors in addition to a recoil propulsion unit increases the mass to be transported into space or into higher atmospheric layers and thus reduces the payload of the launch rocket.

RU 2 603 305 C1 and RU 2 609 539 C1 each show and describe a reusable rocket system for manned space flight. This rocket system has a plurality of recoil thrusters arranged at the rear, lower end of the central tubular rocket fuselage. Four gas turbine engines are provided around this rocket fuselage in its lower section as jet engines. A fuel pump driven by its own drive supplies the combustion chamber of each gas turbine with propellant from a propellant tank. Another fuel pump supplies the respective recoil propulsion unit with fuel.

EP 2 415 966 A1 concerns a drive train for a gas turbine, but not a recoil propulsion unit designed as a rocket motor.

### BRIEF SUMMARY OF THE INVENTION

The object of the present invention is to provide a generic propulsion stage for a launch rocket and a launch rocket equipped therewith, which is mass-optimized and which minimizes the loss of payload. In addition, it is an object of the invention to provide a method for operating such a launcher.

The part of the problem directed to the propulsion stage is solved by a propulsion stage with the features of patent claim 1.

A propulsion stage of a launch rocket, in particular a reusable propulsion stage, with a rocket body having a longitudinal axis is provided with at least one recoil propulsion unit which acts predominantly parallel to the longitudinal axis and to which liquid propellant can be supplied from at least one propellant tank by means of at least one associated fuel pump. The propulsion stage has a plurality of rotor assemblies, each of which can be driven by a rotor drive which comprises at least one motor. This propulsion stage is characterized according to the invention in that the motor of at least one of the rotor drives is designed to selectively drive the rotor assembly and/or a fuel pump of the at least one recoil propulsion unit.

A recoil propulsion unit is understood here to be a generally known arrangement comprising a combustion chamber and a rigid or pivotable thrust nozzle, and a rotor assembly is understood to be an atmospheric propeller with propellers or rotor blades that can be driven by a rotor drive.

The dual use of the respective motor for driving the fuel pump and/or the rotor assembly in accordance with the invention gives the motor a dual function, which makes it possible to use only one drive motor for the fuel pump and the rotor drive, thereby saving mass and thus weight. It is particularly advantageous if the motor of the at least one rotor drive can be coupled either to a drive shaft of the associated rotor drive or to a drive shaft of a fuel pump of the at least one recoil propulsion unit.

If the propulsion stage has a plurality of recoil propulsion units arranged around the longitudinal axis and a plurality of rotor assemblies arranged around the longitudinal axis, whereby the latter can, for example, be arranged in a ring around the longitudinal axis in the manner of a multicopter, it is advantageous if a rotor assembly is assigned to each recoil propulsion unit, preferably radially outside it. It is particularly advantageous if a pair of rotor assemblies is assigned to each pair of recoil propulsion units. In this way, if both recoil propulsion units of a pair are supplied with fuel components (fuel and oxidizer) from the same fuel tanks—one for the fuel and one for the oxidizer—the motor of one rotor assembly can drive the fuel pump for the fuel and the other motor can drive the fuel pump for the oxidizer and can be coupled to these for this purpose.

The invention is not limited to rocket propellants with two liquid propellant components (diergols), but can also be used in an analogous manner with only one propellant component (monergols) or more than two propellant components (e.g. triergols), whereby at least one fuel pump is assigned to each liquid propellant component.

Further preferred and advantageous embodiments of the propulsion stage according to the invention are the subject of subclaims 2 to 7.

In a preferred embodiment of the invention, a first switchable clutch for clutch the motor to a drive shaft of the associated rotor assembly and a second switchable clutch for clutch the motor to a drive shaft of the associated fuel pump are associated with the respective motor. This simple mechanical clutch is reliable and the switchable clutches can be controlled with an electronic control or regulating device.

According to a particularly preferred variant of the invention, which can be combined with other variants, the clutches assigned to the respective motor can be switched alternately. This makes it possible to operate the propulsion stage only with the recoil propulsion unit during the ascent of the launch rocket and to operate only the rotor assemblies during the fall back to earth and in the landing phase.

Preferably, the respective motor has an output shaft which is connected or connectable in the region of its first end to the first switchable clutch and in the region of its second end to the second switchable clutch. This creates a simple and reliable mechanical arrangement that enables both a switchover of the motor output optionally for clutch with the fuel pump or with the rotor assembly as well as a joint clutch of the motor output with the fuel pump and the rotor assembly. Such dual operation can be carried out in the ascent phase of the propulsion stage and thus of the launch rocket, in particular during the transition between a rotor-driven ascent phase and a recoil-driven ascent phase.

Preferably, the respective motor is comprised by an electric motor and at least one current storage device is provided for storing electrical energy and for supplying the respective electric motor with electrical energy. Such electrical operation is locally emission-free and quieter than operating an internal combustion engine or a gas turbine as an engine. The power storage device can have accumulators and/or capacitors, for example so-called supercapacitors, but it can also have at least one fuel cell for generating electrical energy.

It is particularly advantageous if at least some of the electric motors in the state coupled to an associated rotor drive, driven by an associated rotor assembly, can be operated in a generator mode in which electrical energy can be generated, and that the respective electric motors are designed to return the generated electrical energy to the respective associated current storage device. This embodiment of the invention, which can be combined with other embodiments, permits charging of the current storage device(s) during free fall of the propulsion stage in the atmosphere in the return or fall-back phase, the rotors of the rotor assemblies being set into autorotation by the air flow and the associated rotor drive functioning as a generator and producing electrical current which is stored in the current storage devices.

A further embodiment of the invention, which can be combined with other embodiments, provides that the power of the respective motor can be controlled or regulated, in particular via a speed control, both when driving the associated rotor assembly and when driving the associated fuel pump, for which purpose a control or regulating device is provided. This makes it possible not only to control or regulate the thrust generated by the rotor assembly, but also to control or regulate the thrust of the associated recoil propulsion unit via the power of the fuel pump. This is particularly the case if the propulsion stage has a plurality of recoil propulsion units arranged around the longitudinal axis and a plurality of rotor assemblies arranged around the longitudinal axis, whereby the latter can be arranged in a ring around the longitudinal axis in the manner of a multicopter, for example, and if a common motor is assigned to each rotor assembly and each fuel pump, the direction of movement of the propulsion stage can be controlled by controlling or regulating the individual motors, for example by pumping more fuel into the recoil propulsion units on one side of the propulsion stage than on the opposite side of the propulsion stage. This makes it possible, for example, to use simple recoil propulsion units (thrusters) with rigidly installed thrust nozzles instead of more complex swivel nozzles, thereby reducing the complexity and cost of the propulsion stage.

The invention also includes a launcher having at least one propulsion stage, according to any of the foregoing embodiments or combinations thereof.

The part of the problem to be solved relating to the method is solved by a

Method for operating a launch rocket according to the invention, wherein the propulsion stage is driven by the at least one recoil propulsion unit in an ascent phase, wherein the propulsion stage plunges back to earth without propulsion in a fall-back phase after the end of the ascent phase and wherein the propulsion stage is transferred to a landing phase shortly before reaching the earth's surface, in which it moves to a landing position in controlled flight and lands in a controlled manner, and in which at least some of the motors in the ascent phase are coupled to a respectively assigned fuel pump and in which at least some of the motors in the landing phase are coupled to a respective assigned rotor assembly and drive the assigned rotor assembly in a controlled manner. In this method according to the invention, the propulsion stage is intercepted at the end of the fall back to earth phase by the activation of the motors coupled to the rotor assemblies by the lift force generated by the rotors of the rotor assemblies and the propulsion stage can then be flown to a landing site in a precisely controlled manner by means of the rotor assemblies and landed there.

A further development of the method according to the invention is of particular advantage, in which at least some of the motors designed as electric motors are coupled to a respective associated rotor assembly in the fall-back phase and are operated in a generator mode, wherein the associated rotor assemblies drive the associated motor acting as a generator by autorotation of their rotors, and wherein the electrical energy generated thereby is fed back into a respective associated electric current storage device and stored there. In this variant of the method according to the invention, electrical energy is generated when the propulsion stage falls back to earth, which is used to charge the power storage devices. In this way, the electrical energy used in the power storage devices during the ascent phase, for example to operate the fuel pumps, can be replaced by electrical energy recovered during the fall back through the atmosphere. This means that the full capacity of the power storage devices is once again available to the motors during the landing phase in order to supply the rotor assemblies with electrical energy during the return flight to the landing site and during landing. This increases the range for the return flight to the landing site.

Preferred embodiments of the invention with additional embodiment details and further advantages are described and explained in more detail below with reference to the accompanying drawings.

### BRIEF DESCRIPTION OF THE DRAWINGS

FIG. 1 shows a vertical section through a first embodiment of a propulsion stage according to the invention along line I-I in FIG. 2;

FIG. 2 shows a horizontal section through the propulsion stage according to the invention along line II-II in FIG. 1 and

FIG. 3 shows a schematic drawing of a drive group consisting of two recoil propulsion units and two rotor assemblies according to detail III in FIG. 2

### DETAILED DESCRIPTION

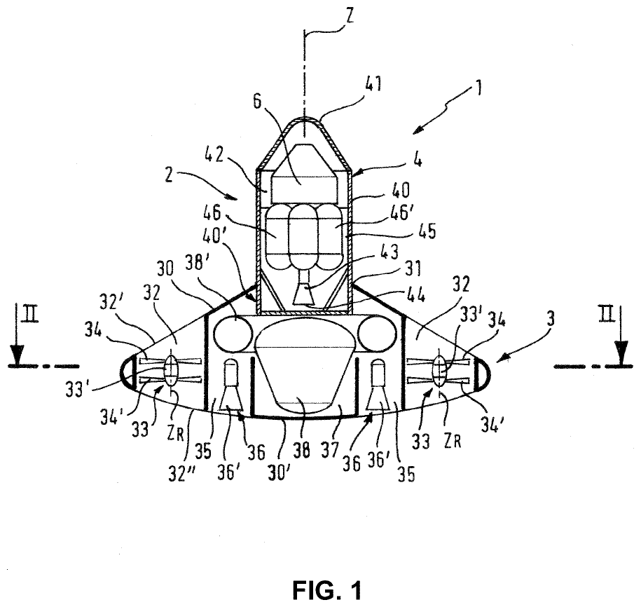

FIG. 1 shows a vertical section through a launch rocket 1 with a rocket body 2, which has a propulsion stage 3 and an upper stage 4.

The upper stage 4 is essentially formed by a cylindrical housing shell 40, which is provided with a fold-down or fold-up hinged conical upper tip 41. A payload compartment 42 for accommodating a payload 6 is formed in the upper area of the upper stage 4, which is accessible by folding up the conical tip 41, so that the payload 6 can be dropped out of the payload compartment 42 in space.

In the lower region of the upper stage 4, i.e. on the underside facing away from the conical tip 41, a recoil propulsion unit 43 is provided, the outlet nozzle 44 of which is directed downwards and arranged coaxially to the vertical longitudinal axis Z of the launch rocket 1. A supply space 45 is provided between the recoil propulsion unit 43 and the payload compartment 42, in which a plurality of propellant tanks 46, 46′ are arranged, which contain the propellants for the operation of the recoil propulsion unit 43 of the upper stage 4 and which are connected to the recoil propulsion unit 43 of the upper stage 4 via corresponding fuel lines (not shown).

The lower area 40′ of the cylindrical housing shell 40 of the upper stage 4 facing away from the conical tip 41 engages in an adapted cylindrical receiving opening 31 in the upper side of the housing shell 30 of the propulsion stage 3 and is detachably inserted there. The upper stage 4 is connected to the propulsion stage 3 in this way so that it can be decoupled.

The housing shell 30 of the propulsion stage 3 has a spherical sector shape with a convex lower wall 30′ facing away from the upper stage 4. The reusable first rocket stage of the launch rocket 1 formed by the propulsion stage 3 has the shape of a flat truncated cone with a convex base, similar to an Apollo capsule. The outer diameter of the propulsion stage 3 is significantly larger than the outer diameter of the cylindrical upper stage 4. In the example shown, the outer diameter of the propulsion stage 3 is approximately four times as large as the outer diameter of the upper stage 4.

In its radially outer area, near the largest circumferential edge of the housing shell 30 of the propulsion stage 3, a plurality of rotor assemblies 33 are provided, spaced apart from one another in the circumferential direction parallel to the longitudinal axis Z of the launch rocket 1, with their respective rotor axis Z_{R} running parallel to the longitudinal axis Z of the launch rocket 1. The rotor assemblies 33 are located inside the housing shell 30. The housing shell 30 has several vertically extending air ducts 32 distributed around the circumference of the propulsion stage 3, in each of which a rotor assembly 33 is arranged. The upper openings 32′ and the lower openings 32″ of the air ducts 32 can be closed in the area of the housing shell 30 by means of protective flaps (not shown).

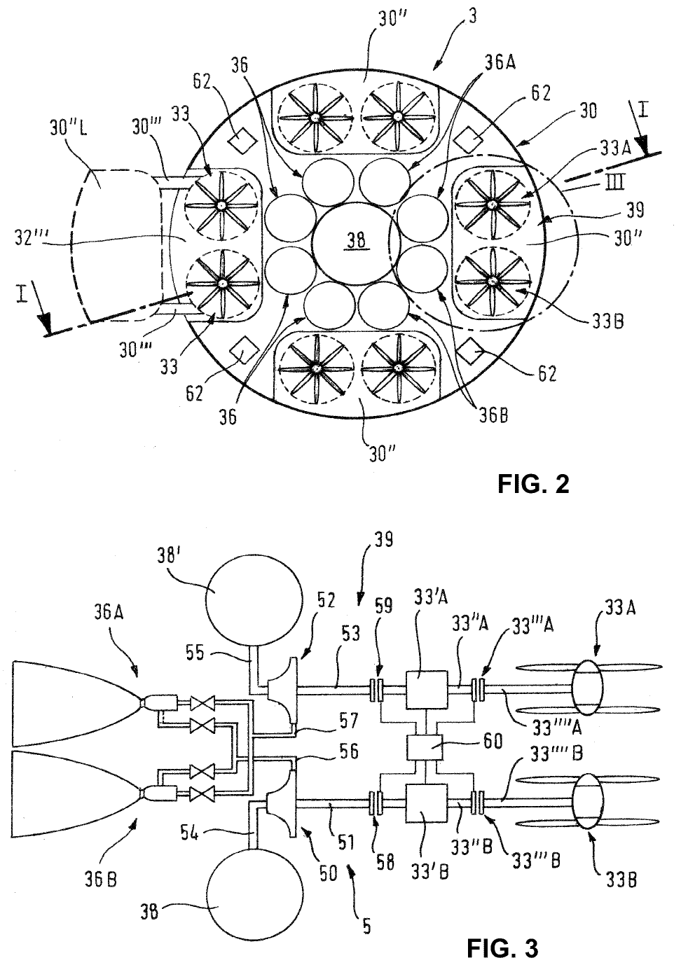

Alternatively, the rotor assemblies 33 are covered by radially outwardly movable housing sections 30″ (FIG. 2), which can be moved radially outwardly for operation of the associated rotor assembly 33, for example on rails 30′″, as shown for the left housing section 30″L with dashed lines in FIG. 2. In this alternative variant, a vertical air duct 32′″, in which at least one respective rotor assembly 33 is located, is also formed between the respective outwardly displaced housing section 30″ and the remaining central part of the housing shell 30. In the example shown in FIG. 2, a pair of such rotor assemblies is located in a parallel-axis air duct 32′″ formed in this way, whereby four radially outwardly movable housing sections 30″ are provided distributed around the circumference at an angle of 90° to each other.

Preferably, eight propeller-like rotor assemblies 33 are provided, each of which can be driven electrically by a rotor drive with a motor 33′ designed as an electric motor (FIG. 2). Each of these rotor assemblies 33 has an upper rotor 34 and a lower rotor 34′, which can be driven in the same direction or in opposite directions (depending on the type of the respective propeller-like rotor 34, 34′) in an operating state driven by the motor 33′ to generate a vertical air flow-in the direction of uplift or in the direction of downlift.

A plurality of recoil propulsion units 36 are provided radially within the rotor assemblies 33 in a respective engine compartment 35, with one recoil propulsion unit 36 being assigned to each rotor assembly 33. The outlet nozzle 36′ of the respective recoil propulsion unit 36, which forms a thrust nozzle, is directed away from the payload compartment 42 and opens downwards. The engine compartment 35, which is open at the bottom during operation of the recoil propulsion units 36, can be closed by at least one protective flap (not shown). In particular during a nosedive of the reusable propulsion stage 3 back to earth, these protective flaps close the respective engine compartment 35.

A central fuel tank 38 for storing a fuel and an annular fuel tank 38′ for storing an oxidizer for supplying the recoil propulsion units 36 are arranged in a central interior area 37 radially inside and above the engine compartments 35.

In FIG. 3, in accordance with detail III in FIG. 2, a propulsion group 39 consisting of two recoil propulsion units 36A, 36B with a common fuel supply device 5 and two rotor assemblies 33A, 33B is shown schematically. A motor 33′A, 33′B designed as an electric motor is assigned to each of the rotor assemblies as a rotor drive. The drive shaft 33″A, 33″B of a respective motor 33′A, 33′B can be coupled at its one end via an associated first clutch 33′″A, 33′″B to a drive shaft 33″″A, 33″″B of the respective rotor assembly 33A, 33B for torque transmission.

The fuel supply device 5 has a first fuel pump 50 for the fuel and a second fuel pump 52 for the oxidizer. Typically, these fuel pumps 50, 52 are designed as turbopumps with a stator and a rotor rotating with a drive shaft 51, 53. The respective fuel pump 50, 52 is in fluid connection with a respective fluid inlet via a supply line 54, 55 with the respective associated fuel tank 38, 38′. A first common fuel pressure line 56 for the fuel and a second common fuel pressure line 57 for the oxidizer lead from a respective propellant outlet of each fuel pump 50, 52 to the two associated recoil propulsion units 36A, 36B. The drive shaft 51 of the first fuel pump 50 for the fuel can be coupled via an associated clutch 58 to the other end of the output shaft 33″B of the engine 33′B for torque transmission, and the drive shaft 53 of the second fuel pump 52 for the oxidizer can be coupled via an associated clutch 59 to the other end of the output shaft 33″A of the engine 33′A for torque transmission.

The respective motor 33′A, 33′B can therefore be switched between a drive connection with the respective associated rotor assembly 33A, 33B for driving the rotors 34, 34′ and a drive connection with the respective associated fuel pump 50, 52 by means of a control or regulating device 60 which applies control signals to the clutches 33′″A, 33′″B, 58, 59 and preferably also to the motors 33′A, 33′B. In special cases, the output shaft 33″A, 33″B of the respective motor 33′A, 33′B can also be coupled both to the associated rotor assembly 33A, 33B and to the associated fuel pump 50, 52 by closing both associated clutches 33′″A, 58 and 33′″B, 59 respectively. Even in the return or fall-back phase of the propulsion stage, the respective motor 33′A, 33′B is coupled by a closed clutch connection to the drive shaft 33″″A, 33″″B of the respective associated rotor assembly 33A, 33B for torque transmission, so that the rotors 34, 34′ of the respective rotor assembly 33A, 33B, which are driven for autorotation by the air flow impinging on the falling propulsion stage 3, drive the motor 33′A, 33′B, which now acts as a generator. The electric current generated by the motor 33′A, 33′B is stored in at least one associated electric current storage device 62 (FIG. 2).

Reference signs in the claims, the description and the drawings serve only to facilitate understanding of the invention and are not intended to limit the scope of protection.

### REFERENCE NUMERALS AND DESIGNATIONS

1 launch rocket
2 rocket body
3 propulsion stage
4 upper stage
5 fuel supply device
6 payload
30 housing shell
30′ convex lower wall
30″ radially outwardly movable housing sections
30″L left housing section that can be moved outwards
30′″ rails
31 adapted cylindrical receiving opening
32 air duct
32′ upper opening of the air duct
32″ lower opening of the air duct
32′″ air duct
33 rotor assembly
33A rotor assembly
33B rotor assembly
33′ motor
33′A motor
33′B motor
33″A drive shaft of the motor 33′A
33″B drive shaft of the motor 33′B
33′″A first clutch
33′″B first clutch
33″″A drive shaft of the rotor assembly 33A
33″″B drive shaft of the rotor assembly 33B
34 upper rotor
34′ lower rotor
35 engine compartment
36 recoil propulsion unit
36A recoil propulsion unit
36B recoil propulsion unit
36′ outlet nozzle
37 central interior area
38 central fuel tank
38′ ring-shaped fuel tank
39 propulsion group
40 cylindrical housing shell
40′ lower area of the cylindrical housing shell
41 conical upper tip
42 payload compartment
43 recoil propulsion unit
44 outlet nozzle
45 supply space
46 fuel tank
46′ fuel tank
50 first fuel pump
51 drive shaft
52 second fuel pump
53 drive shaft
54 supply line
55 supply line
56 first common fuel pressure line
57 second common fuel pressure line
58 clutch
59 clutch
60 control or regulating device
62 electric current storage device
Z vertical longitudinal axis
Z_{R} rotor axis

What is claimed is:

1. A propulsion stage for a launch rocket, the propulsion stage comprising:
a rocket body having a longitudinal axis;
at least one recoil propulsion unit acting substantially parallel to the longitudinal axis, wherein a liquid propellant is supplyable to the at least one recoil propulsion unit from at least one propellant tank through at least one fuel pump; and
a plurality of rotor assemblies, each drivable by a rotor drive including at least one motor,
wherein the at least one motor of at least one of the rotor drives is configured to selectively drive at least one of the rotor assemblies and/or the at least one fuel pump of the at least one recoil propulsion unit.

2. The propulsion stage according to claim 1, wherein the at least one motor cooperates with a first switchable clutch configured to couple to a drive shaft of the at least one rotor assembly and with a second switchable clutch configured to couple to a drive shaft of the at least one fuel pump.

3. The propulsion stage according to claim 1, wherein the first switchable clutch and the second switchable clutch are configured to cooperate with the at least one motor and are switchable alternatively.

4. The propulsion stage according to claim 2, wherein the at least one motor includes an output shaft which is connected or connectable at its first end to the first switchable clutch and is connected or connectable at its second end to the second switchable clutch.

5. The propulsion stage according to claim 2, wherein the at least one motor is an electric motor and at least one current storage device is provided for storing electrical energy and for supplying the at least one motor with the electrical energy.

6. The propulsion stage according to claim 5,
wherein the at least one motor coupled to the at least one of the rotor drives and driven by the at least one rotor assembly, is operable in a generator mode in which electrical energy is generatable, and
wherein the at least one motor is configured to return generated electrical energy to the at least one current storage device.

7. The propulsion stage according to claim 1, wherein a power the at least one motor is controllable or regulatable via a speed control when driving the at least one of the rotor assemblies and when driving the fuel pump.

8. A launch rocket, comprising: the propulsion stage according to claim 1.

9. A method for operating the launch rocket according to claim 8,
wherein the propulsion stage is driven in an ascent phase by the at least one recoil propulsion unit,
wherein the propulsion stage plunges back to earth without drive in a fall-back phase after the end of the ascent phase, and wherein the propulsion stage is transferred into a landing phase shortly before reaching the earth's surface, in which it heads for a landing position in controlled flight and lands in a controlled manner,
wherein at least some of the motors are coupled to a respectively assigned fuel pump in the ascent phase, and at least some of the motors are coupled to a respective associated rotor assembly in the landing phase and drive the associated rotor assembly in a controlled manner.

10. The method according to claim 9 for operating the launch rocket,
wherein at least some of the motors configured as electric motors are coupled to a respectively assigned rotor assembly in the fall-back phase and are operated in a generator mode, the respectively assigned rotor assembly driving the assigned motor acting as a generator by autorotation of its rotors and wherein the electrical energy generated thereby is fed back into a respectively associated electric current storage device and stored there.
